(19) United States
(12) Patent Application Publication
(10) Pub. No.: US 2006/0095563 A1
(43) Pub. Date: May 4, 2006

(54) Method and apparatus for presenting network displays utilizing animation

(76) Inventors: Shai Benjamin, Dobbs Ferry, NY (US); Josepha Schoss, Ossining, NY (US)

Correspondence Address: Carl A. Giordano, Esq.;System Management ARTS, Inc., 7th Floor, 44 S. Broadway, White Plains, NY, 10601, US

(21) Appl. No.: 10/977,024

(22) Filed: Oct. 29, 2004

(51) Int. Cl. G06F 17/00

(52) U.S. Cl. 709/224; 715/734; 715/736; 715/977; 715/709

(57) ABSTRACT

A method and apparatus for presenting or displaying operations associated with a network is disclosed. The method comprises the steps of selecting a path that allows communications between two selected nodes in the network, wherein the path consisting of a plurality of communication paths providing communication between communicatively adjacent nodes, determining parameters for animating the selected path; and highlighting, alternately, selected portions of the display of the selected path based on the determined parameters, wherein the alternate highlighting provides a visual indication of a direction of data flow in the selected path. In one aspect of the invention, the rate of alternate highlighting may further be selected to provide an indication of the status of corresponding communication paths.

### FIELD OF THE INVENTION

This invention is related to the field of network management and more specifically to displaying network operations.

### BACKGROUND

Methods for network management have continued to evolve as networks have become more complex, larger and essential to business operations. Fails in networks can cause businesses to incur significant losses as employees are not able to communicate with one another or customers and clients are not able to order a company's products. Hence, continuous monitoring of a company's network is critical so that problems may be detected, isolated and corrected before the severity of the problem escalates.

Numerous methods are known in the art for displaying critical network information for monitoring networks. Textual displays may be used to tabulate network components or elements and associated characteristics. For example, routers may be identified by name or number along with corresponding status or operating efficiency. Similarly, communications paths between routers may be identified by their data load capability along with a corresponding status or current data load. Another method is to present the network elements in a visual map that includes icons that represent routers and links that represent communication paths between the routers.

There are many ways to distinguish an element or path in a map that represents a collection of network nodes or routers and edges, wherein edges are representative of physical or logical connections between the nodes. One way is to highlight, for example, a communication path between a source node and a destination node, by tracing the path with a distinguishing color. Another way could be to change the look of the path by manipulating its widths or continuity, i.e., dashed or dotted lines. Direction of data flow is often shown by adding an arrow head in the direction of the destination node.

However, network and other maps can become very crowded as the size of the network or the number of elements increases. Often, there are many connections between two nodes, and changing colors to highlight a selected connection may not significantly distinguish it from the others.

Further, colors are also used conventionally in maps to denote the status of an element. For example, conventional status indicators are a red color to denote a device not operating correctly, and a green color for normal operation. Using another color for highlighting a path can also make the map very busy and hard to read. A disadvantage of using red/green colors is that operators who do not have the ability to distinguish red/green colors are able to see the highlighting.

Further, when there are multiple connections between two nodes, making one thicker connection may not be significantly distinguishable over the other connections between the same or different node.

Hence, there is a need in the industry for a means and apparatus for simplifying the presentation of network operations while providing sufficient information regarding network status.

### SUMMARY OF THE INVENTION

A method and apparatus for presenting or displaying operations associated with a network is disclosed. The method comprises the steps of selecting a path that allows communications between two selected nodes in the network, wherein the path consisting of a plurality of communication paths providing communication between communicatively adjacent nodes, determining parameters for animating the selected path; and highlighting, alternately, selected portions of the display of the selected path based on the determined parameters, wherein the alternate highlighting provides a visual indication of a direction of data flow in the selected path. In one aspect of the invention, the rate of alternate highlighting may further be selected to provide an indication of the status of corresponding communication paths.

### BRIEF DESCRIPTION OF THE FIGURES

FIG. 1a illustrates a conventional network display;

FIG. 1b illustrates a conventional display of paths between the nodes shown in FIG. 1a;

FIG. 1c illustrates a conventional display of LSPs between customer nodes shown in FIG. 1a;

FIG. 1d illustrates a conventional display of collected LSPs between customer nodes shown in FIG. 1a;

FIG. 2a and 2b illustrates aspects of the present invention;

FIG. 3 illustrates a second aspect of the invention;

FIGS. 4a-4c collectively illustrate operational aspects of the present invention;

FIGS. 5a-5c collectively illustrate a second operational aspect of the present invention;

FIG. 6a illustrates a flow chart of an exemplary process in accordance with the principles of the invention;

FIG. 6b illustrates a flow chart of an exemplary process for determining animation parameters in accordance with the principles of the invention; and

FIG. 7 illustrates a system for performing the processing shown herein.

It is to be understood that these drawings are solely for purposes of illustrating the concepts of the invention and are not intended as a definition of the limits of the invention. The embodiments shown in the figures herein and described in the accompanying detailed description are to be used as illustrative embodiments and should not be construed as the only manner of practicing the invention. Also, the same reference numerals, possibly supplemented with reference characters where appropriate, have been used to identify similar elements.

### DETAILED DESCRIPTION

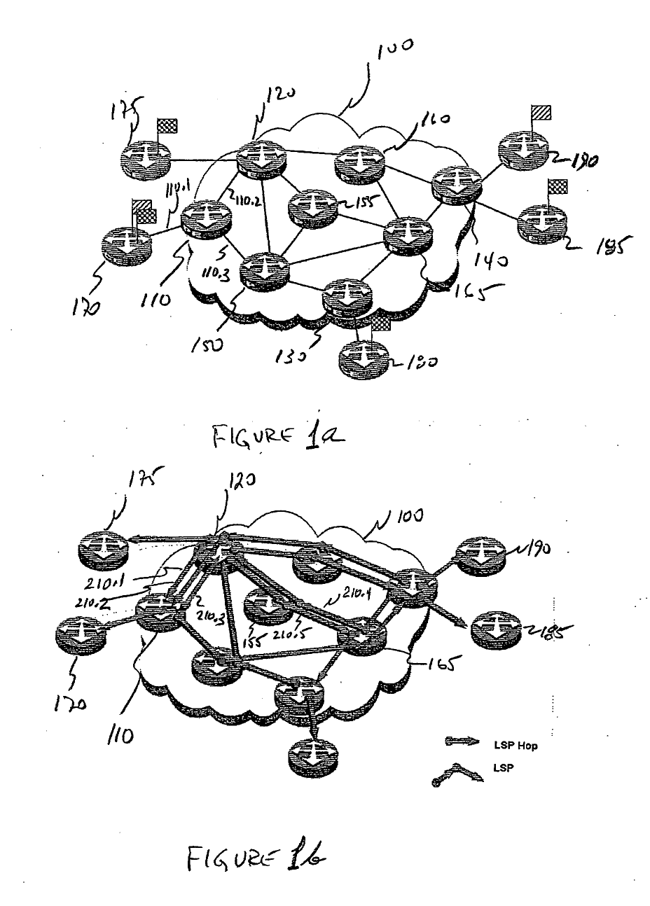

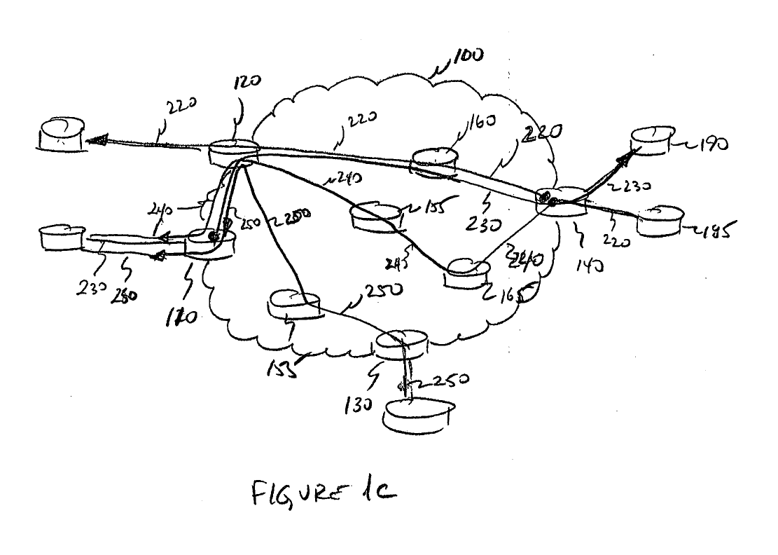

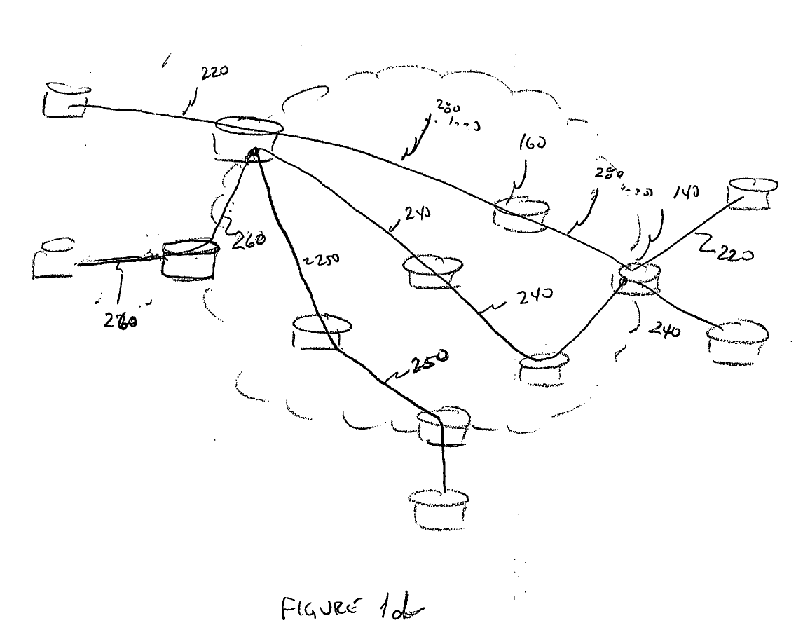

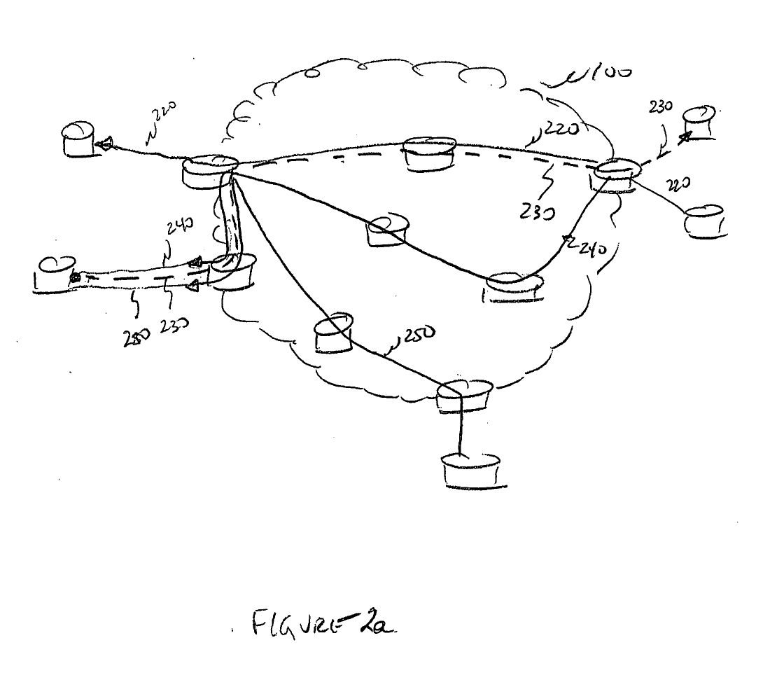

FIG. 1a illustrates a conventional network 100 containing provider edge nodes (PE) 110, 120, 130, and 140 and provider nodes (P) 150, 155, 160 and 165. Provide edge nodes 110-140 represent ingress and egress points between network 100 and customer edge nodes 170, 175, 180, 185 and 190. The links connecting each node, e.g., 110.1, 110.2, 110.3 associated with node 110, represent communication paths among the nodes.

FIG. 1b illustrates a conventional method for displaying the communication paths between the nodes shown in FIG. 1a. For example, between PE nodes 110 and 120, three individual paths are shown; two paths 210.1, 210.2, from node 120 to node 110 and one path 210.3 from node 110 to node 120. The direction of the communication is represented by the direction of the arrow head. Similarly, two communication paths are shown between node 120 and node 165; one path 210.5 from node 120 to node 165, and one path 210.4 from node 165 to node 120. Further, each of these paths pass through node 155.

FIG. 1c illustrates another conventional method for displaying communication paths, which are referred to as LSPHops, in a Multiple-Protocol Label Switched (MPLS) network. MPLS networks are well-known in the art and need not be explained in detail herein.

In this illustrative representation of the MPLS network, the LSPHops are grouped together as paths, referred to as Label Switch Paths (LSPs) between customers. Limiting the display to LSPs 220, 230, 240 and 250, as shown, provides some clarity to the display shown in FIG. 1b. In this case, the segments of each LSP 220, 230, 240 and 250, are shown in order to follow identify each LSP. In a conventional display, the LSPs may be color-coded to distinguish one path from another. However, while the display is somewhat less dense, the use of color to distinguish the LSP may require a significant number of different colors to uniquely illustrate each LSP. Further, even with this clearly presentation it is still difficult to determine direction of data flow and the status of that data flow.

FIG. 1d illustrates an even further improvement to the display of the LSPs shown in FIG. 1c. In this case, segments of LSPs are grouped together in higher-order LSPs. For example, segment 260 represents segments where LSPs 230, 240 and 250 possess a common path. Similarly, segment 280 represents segments where LSPs 220 and 230 possess a common path. Here again the density of the display is reduced, however, a determination of data flow and the status of that data flow is lost.

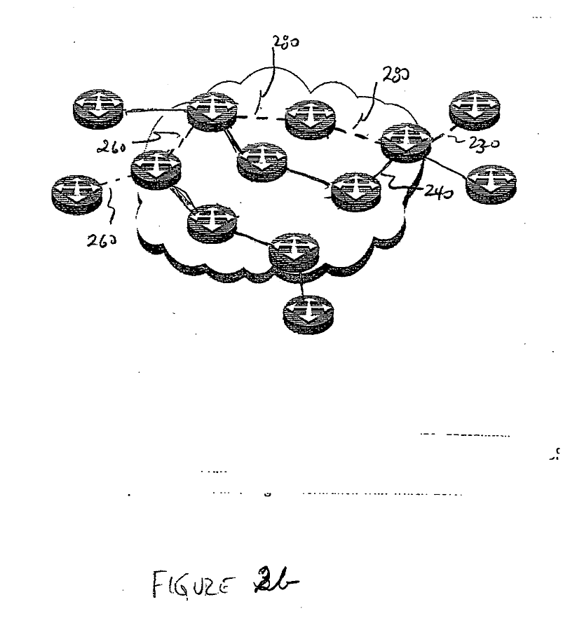

FIG. 2a illustrates an exemplary aspect of the LSP display shown in FIG. 1c enhanced with animation in accordance with the principles of the invention. In this illustrative example, selected LSP 230 is shown in dashed lines to represent animated form, and the direction of animation is representative of the direction of data flow. Animation in this case is represented by dashed lines. As would be known in the art, animation may be visually presented by altering the intensity o f , or highlighting, a portion of the selected LSP to provide the appearance of direction of data flow to an operator. In addition, the highlighted portion and the duration of highlighting the selected portion may be adjusted to represent a data flow or data rate.

In one aspect of the invention (not shown), each LSP may be concurrently animated. In another aspect of the invention, only selected LSPs may be animated. Further, the underlying LSPHops in a selected LSP may be viewable and further selectable. Similarly, selection of the physical components represented by the selected LSPHop may further be selected.

FIG. 2b illustrates an exemplary aspect of the LSP display shown in FIG. 1d enhanced with animation in accordance with the principles of the invention. In this illustrative example, the combined LSP segments are shown in animated form (i.e., dashed lines) wherein the direction of animation is representative of the direction of the data flow. As discussed previously, animation is represented by dashed lines, which are visually altered in intensity or highlighted to provide the appearance of direction of data flow to an operator.

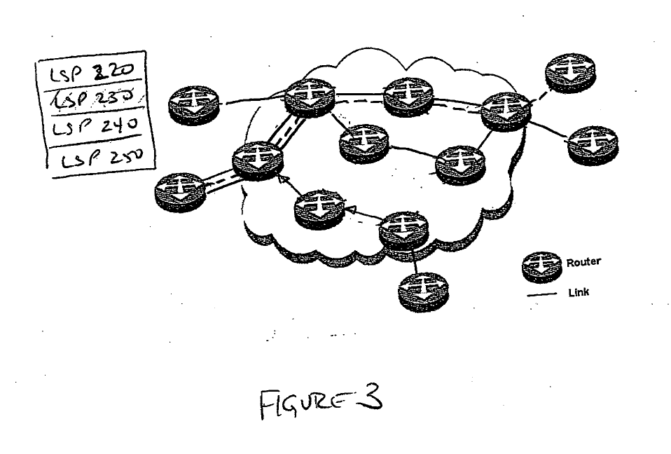

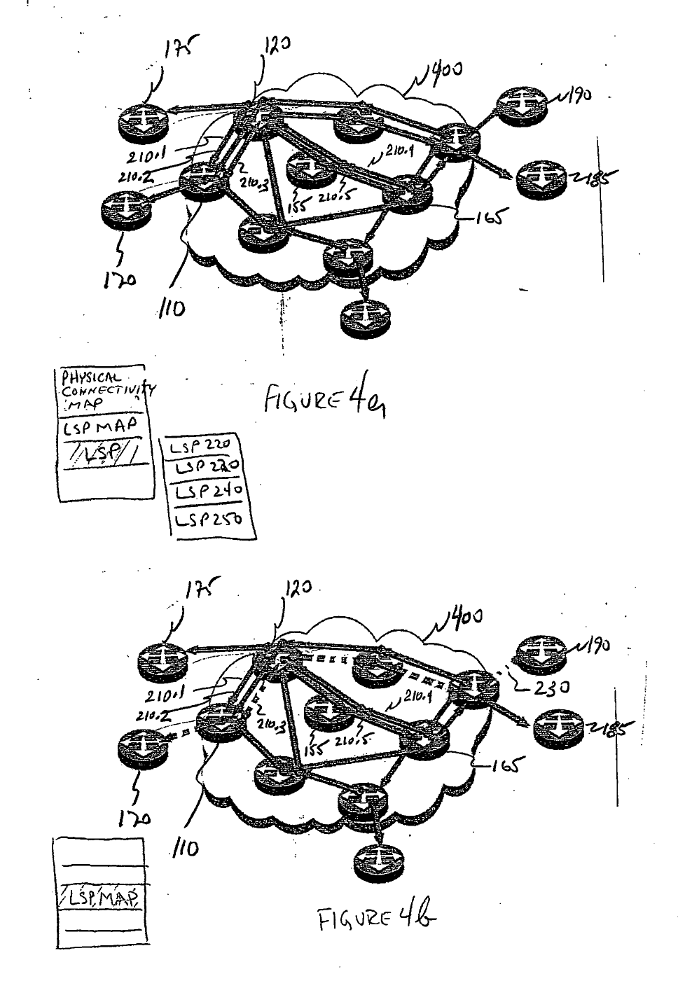

FIG. 3 illustrates an example of the selection of an LSP using a drop-down menu, which includes the names of the LSPs shown in FIG. 1c. In this example, LSP 230 is selected (as indicated by the hashed lines) and, hence, is animated (shown in dashed lines, in the direction of data flow). Selection of LSPHop associated with LSP 230 may further provide information regarding the characteristics of an LSPHop. As would be recognized, selection of LSP or LSPHop may be made by using a pointing device and known pointing techniques, e.g., “point&click.”

In another aspect of the invention, the speed or color of the animation may be a function of a data link bit rate transfer or a bandwidth. In this case, the animation speed/color may be representative of a status condition. For example, a link, LSPHop or LSP may be animated at a first rate when the associated link is determined to be operating above a first threshold of link data rate capacity and a second, slower, rate when operating above a second threshold of link data rate capacity, etc., where the first threshold level is higher than the second threshold. In still another aspect, the animation rate may be used to provide a visible indication of the data load on each LSPHop or LSP.

With regard to determining an LSPHop or LSP status, in one aspect data bit transfer rates or bandwidths of each physical link in an LSPHop or LSP may be normalized with respect to the link's capabilities. In this case, the speed of animation of an LSPHop or LSP may be set to the lowest value of all the links that comprise the LSPHop or LSP. In this case, if some physical links are operating at 100 percent data rate efficiency (normalized value 1.0) and others at 50 percent data rate efficiency (normalized value 0.5), then the animation speed may be set to indicate the lower data rate. Individual link performance may then be determined by reviewing each of the physical links represented by the LSPHop or LSP. Similarly, a color-coding may also be used in addition to the animation. In another aspect, the physical link data flow capacity may be animated. In this case, capacity of each link represented by the LSPHop or LSP may be represented by a normalized value and the animation speed altered to reflect the poorest capacity.

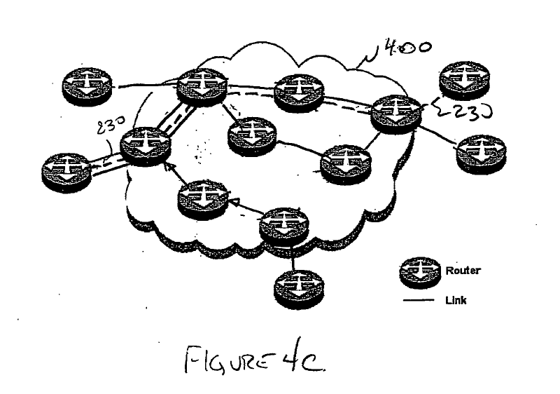

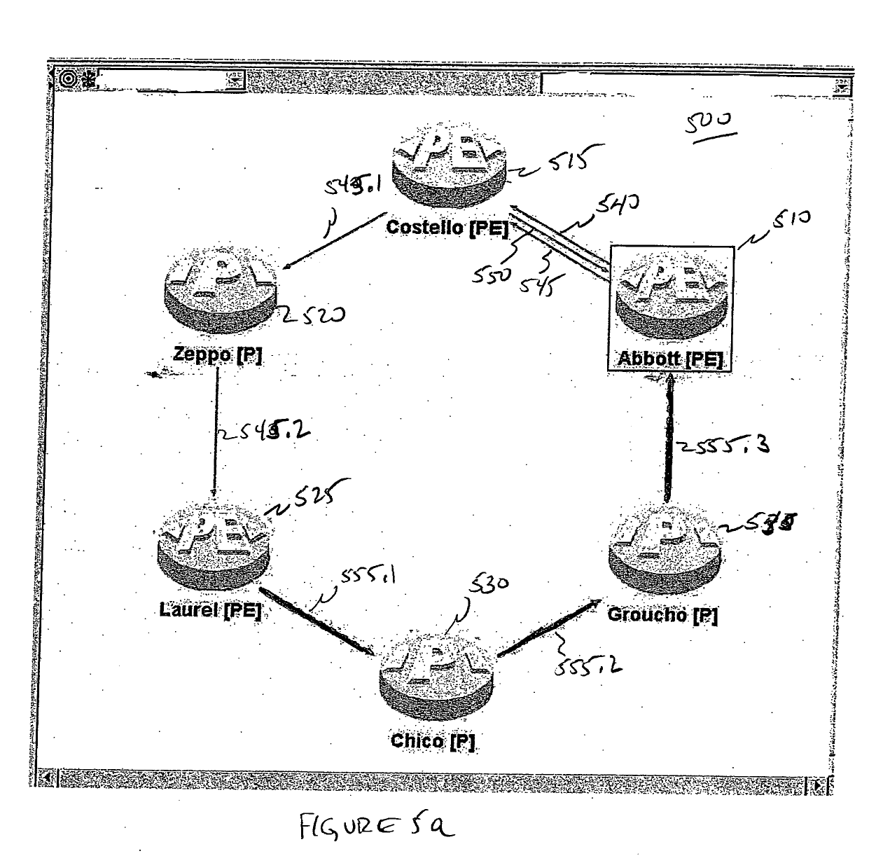

FIGS. 4a-4c collectively illustrate an operation of the present invention. FIG. 4a illustrates an LSPHop network map 400, similarly to that of FIG. 1b. Also, shown is a pull-down menu identifying operations, functions or other maps that may be accessible. In this illustrative example, the identified operation “LSP” is selected, as indicated by the hashed lines, and a second pull-down menu associated with the selected operation is display. The second pull-down menu identifies each of the LSPs included in network 400, which are those shown in FIG. 1c. FIG. 4b illustrates the presentation of network map 400 when LSP 230 is selected. In this case, the LSPHops associated with the selected LSP 230 is shown in an animated form, wherein the dashed lines represent animation and the direction of animation represents direction of data flow.

FIG. 4b further illustrates a pull-down menu similar to that shown in FIG. 4a. In this case, the operation “LSP Map” is selected, as indicated by the hashed lines. FIG. 4c illustrates the presentation of network map 400 altered to show LSPs while retaining the selection of LSP 230. FIG. 4c illustrates the selection of an LSP which is similar to that shown in FIGS. 2a and 3. In another aspect, a similar operation may be performed to display collected LSPs as is shown in FIG. 2b.

In still another aspect of the inventions, operations may be performed to present more detailed information regarding individual LSPHops or physical entities or components within the LSPHops or segments of LSPHops. In these cases the direction of the animation continues to represent the direction of data flow and the speed and/or color of the animation may represent the status of an individual link.

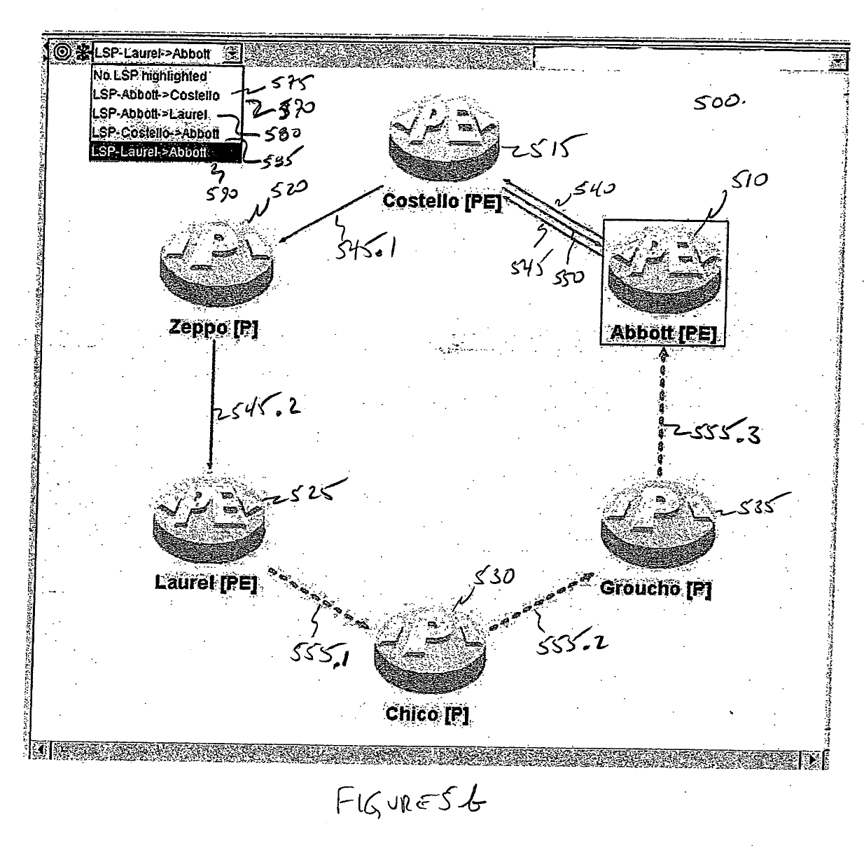

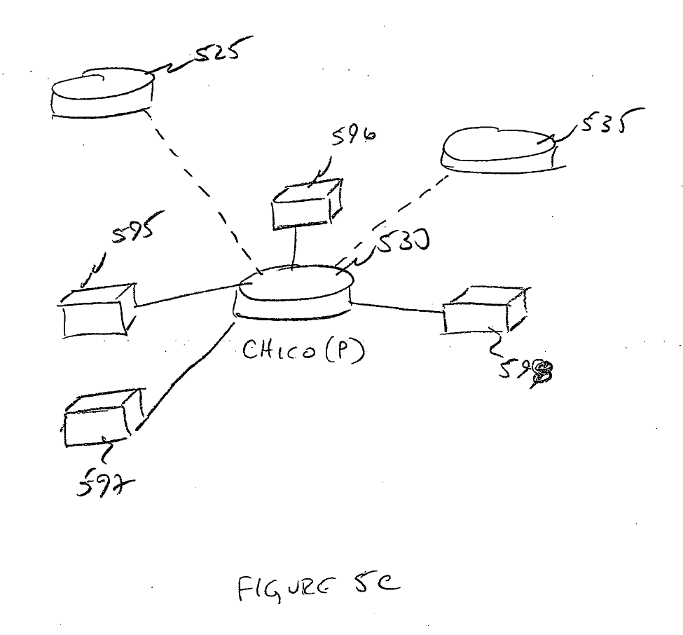

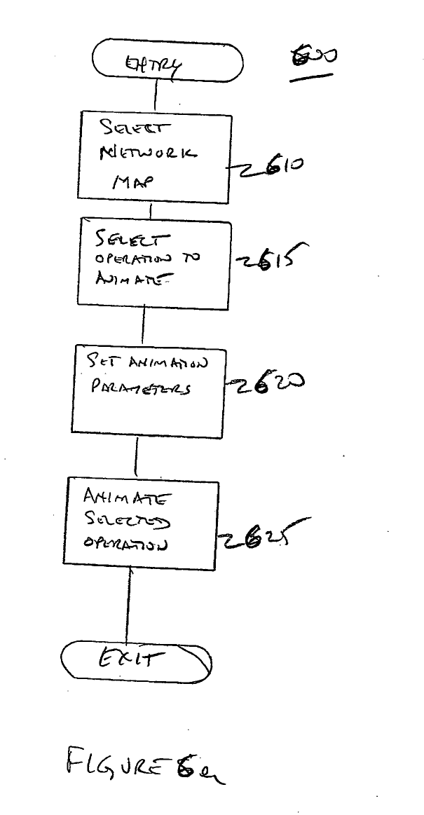

FIGS. 5a-5c illustrate a second example of an operation in accordance with the principles of the invention. FIG. 5a illustrates a network 500 comprising 6 nodes, 510-535. Communication paths 540 and 545 are shown capable of providing information between nodes 510 and 515 as denoted by the direction of the arrowhead on each of paths 540 and 545. Similarly, communication path 550 is capable of providing information between nodes 515 and 510. As shown is communication path 545.1 and 545.2 between nodes 515 and 520 and 520 and 525, respectively. These paths are referenced to path 545 as they are associated with an overall communication path, which has been referred to herein as an LSP, between nodes 510 and 525. Similarly, communication paths 555.1, 555.2, and 555.3 represent an overall communication path between nodes 525 and 510. The communication paths shown are similar to the LSPHops shown with regard to an MPLS network of FIGS. 1a-1d.

FIG. 5b illustrates the selection and animation of the communication paths between bodes 525 and 510. In this illustrative case, a path is selected by a drop-down menu 570 that contains the identifications of each LSP in the network. For example, “LSP-Abbott->Costello” 575 is associated with the communication path 540 between nodes 510 and 515. Similarly, path, “LSP-Laurel->Abbott” 590 is associated with the communication path 555.1, 555.2 and 555.3. In this illustrative example, LSP-Laurel->Abbott 590 is selected and shown by dashed lines to indicate animation. As noted previously, the direction of the animation provides an indication of the data flow.

FIG. 5c illustrates a physical connectivity map displays associated with selected node 530. Physical connectivity map illustrates routers, switches and hosts electrically connected to node 530. In addition, interfaces, ports, and port/port, interface/port and/or interface/interface connections may be shown. In this illustrative example, the communication path between nodes 525 and 535 passing through node 530, which was selected in FIG. 5b is further shown as dashed lines to indicate animation as previously discussed.

Although not shown, but as discussed previously, multiple LSPHops or paths, associated with different nodes or communication paths may be selected and animated concurrently.

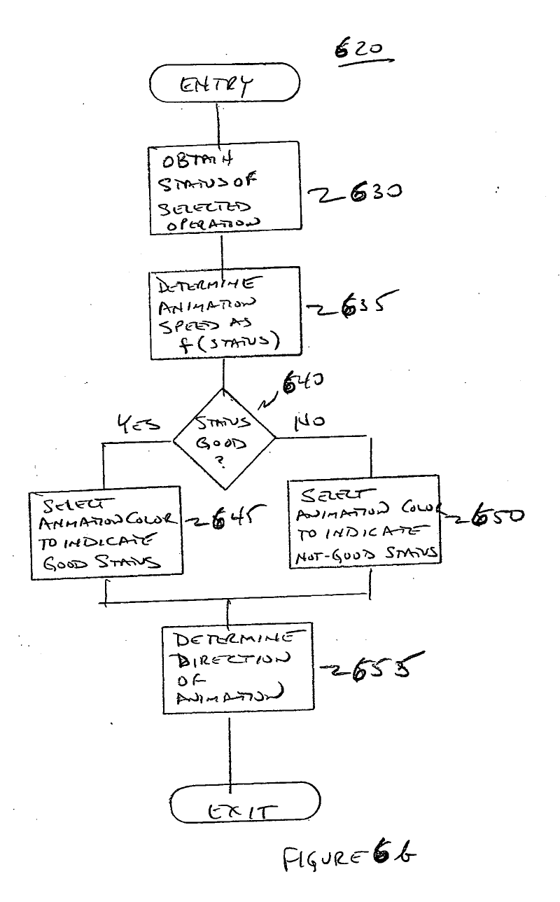

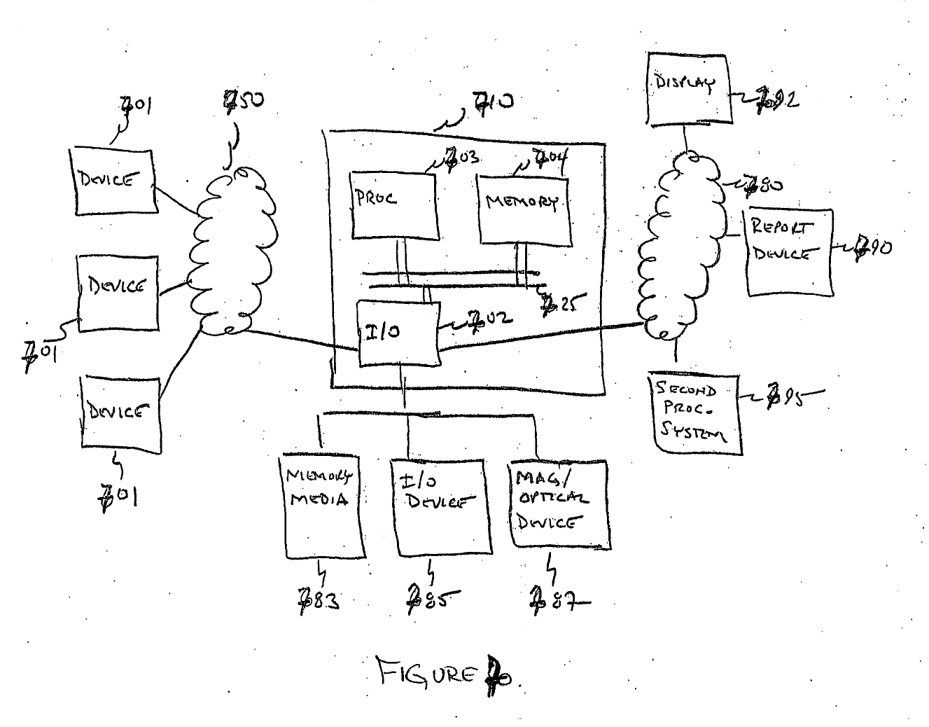

FIG. 6a illustrates a flow chart 600 of an exemplary process for providing animation in network displays in accordance with the principles of the invention. At block 610, a network map is selected and viewed. The map may be similar to one of those shown in FIGS. 1a-1d. At block 615 an operation, e.g., LSP, LSPHop, is selected and the corresponding elements in the selected map are determined. At block 620, the parameters associated with the animated display are determined and at block 625, the corresponding elements associated with the selected operation are displayed in an animated form.

FIG. 6b illustrates a flow chart of an exemplary process for determining animation parameters, i.e., block 620, in accordance with the principles of the invention. In this exemplary process, a status of the selected operation is obtained at block 630. At block 635, the animation speed is determined. The speed is selected to provide a user with an impression of movement, in a selected direction. In one aspect of the invention, the speed may be determined as a function of an operational status. For example, the animation speed may be adjusted slower than a nominal, predetermined, speed, when a degraded status is determined. Similarly, at block 640 a determination may be made to determine whether the link status is indicated to be “good” or normal. In one aspect, the color of the animation may be selected to be a first color when the status is indicated to be good, i.e., block 645, and, may be selected to be a second color when the status is indicated to be degraded, i.e., block 650. At block 655, a determination of the direction of the animation based on the data flow direction is made.

FIG. 7 illustrates an exemplary embodiment of a system or apparatus 700 that may be used for implementing the principles of the present invention. System 700 includes processing unit 710 that may contain one or more input/output devices 702, processors 703 and memories 704. I/O devices 702 may access or receive information from one or more sources or devices 701. Sources or devices 701 may be devices such as routers, servers, computers, notebook computer, PDAs, cells phones or other devices suitable for transmitting and receiving information responsive to the processes shown herein. Devices 701 may have access over one or more network connections 750 via, for example, a wireless wide area network, a wireless metropolitan area network, a wireless local area network, a terrestrial broadcast system (Radio, TV), a satellite network, a cell phone or a wireless telephone network, or similar wired public networks, such as POTS, INTERNET, LAN, WAN and/or private networks, e.g., intranets, as well as portions or combinations of these and other types of networks. Network 750 may similarly represent a communication bus, such as PCI USB, Firewire, etc., that allows communication between device 701 and I/O device 702.

Input/output devices 702, processors 703 and memories 704 may communicate over a communication medium 725. Communication medium 725 may represent, for example, a bus, a communication network, one or more internal connections of a circuit, circuit card or other apparatus, as well as portions and combinations of these and other communication media. Input data from the devices 701 is processed in accordance with one or more programs that may be stored in memories 704 and executed by processors 703. Memory 704 may be selected preferably from semiconductor memories such as a Read-Only Memory (ROM), a Programmable ROM, a Random Access Memory, which is accessible through medium 725 or may be a cache memory in direct communication with processors 703. Processors 703 may be any means, such as general purpose or special purpose computing system, such as a laptop computer, desktop computer, a server, handheld computer, or may be a hardware configuration, such as dedicated logic circuit, or integrated circuit. Processors 703 may also be Programmable Array Logic (PAL), or Application Specific Integrated Circuit (ASIC), etc., which may be “programmed” to include software instructions or code that provides a known output in response to known inputs. In one aspect, hardware circuitry may be used in place of, or in combination with, software instructions to implement the invention. The elements illustrated herein may also be implemented as discrete hardware elements that are operable to perform the operations shown using coded logical operations or by executing hardware executable code.

In a one aspect, the processes shown herein may be represented by computer readable code stored on a computer readable medium. The code may also be stored in the memory 704. The code may be read/downloaded from a memory medium 783, an I/O device 785 or magnetic or optical media, such as a floppy disk, a CD-ROM or a DVD, 787. The downloaded computer readable code may be stored in memory 704 or executed directly by processor 703.

Information from device 701 received by I/O device 702, after processing in accordance with one or more software programs operable to perform the functions illustrated herein, may also be transmitted over network 780 to one or more output devices represented as display 792, reporting device 790, e.g., printer, or second processing system 795. Network 780 may be physically be the same as network 750 or may be a different network that operates on the same or different communication principles as that of network 750.

While there has been shown, described, and pointed out fundamental novel features of the present invention as applied to preferred embodiments thereof, it will be understood that various omissions and substitutions and changes in the apparatus described, in the form and details of the devices disclosed, and in their operation, may be made by those skilled in the art without departing from the spirit of the present invention. It is expressly intended that all combinations of those elements that perform substantially the same function in substantially the same way to achieve the same results are within the scope of the invention. Substitutions of elements from one described embodiment to another are also fully intended and contemplated.

1. A method for presenting operations associated with a network comprising a plurality of nodes and communications path between the nodes, the method comprising the steps of:
selecting a path that allows communications between two selected nodes, the path consisting of a plurality of communication paths providing communication between communicatively adjacent nodes;
determining parameters for animating the selected path; and
highlighting, alternately, selected portions of the display of the selected path based on the determined parameters, wherein the alternate highlighting provides a visual indication of a direction of data flow in the selected path.

2. The method as recited in claim 1, wherein the step of determining parameters for animating the selected path further comprises the steps of:
obtaining a status of the selected path; and
determining parameters for animating the selected path based on the status.

3. The method as recited in claim 2, wherein the step of determining parameters for animating the selected path further comprises the steps of:
obtaining a status of each of the communication paths between communicatively adjacent nodes; and
determining parameters for animating each of the communication paths between the communicatively adjacent nodes based on the associated status.

4. The method as recited in claim 1, wherein the animation parameters are selected from the group consisting of: color, speed, direction.

5. The method as recited in claim 4, wherein the animation speed is representative of an operational status associated with the selected path.

6. The method as recited in claim 4, wherein the animation speed is representative of an operational status associated with each of the communication paths in the selected path.

7. The method as recited in claim 1, wherein the determined parameters are predetermined.

8. An apparatus for presenting operations associated with a network comprising a plurality of nodes and communications path between the nodes, the apparatus comprising:
a processor in communication with a memory, the processor executing code for:
selecting a path that allows communications between two selected nodes, the path consisting of a plurality of communication paths providing communication between communicatively adjacent nodes;
determining parameters for animating the selected path; and
highlighting, alternately, selected portions of the display of the selected path based on the determined parameters, wherein the alternate highlighting provides a visual indication of a direction of data flow in the selected path.

9. The apparatus as recited in claim 8, wherein the processor further executing code for:
obtaining a status of the selected path; and
determining parameters for animating the selected path based on the status.

10. The apparatus as recited in claim 9, wherein the processor executing code for:
obtaining a status of each of the communication paths between communicatively adjacent nodes; and
determining parameters for animating each of the communication paths between the communicatively adjacent nodes based on the associated status.

11. The apparatus as recited in claim 8, wherein the animation parameters are selected from the group consisting of: color, animation speed, animation direction.

12. The apparatus as recited in claim 11, wherein the animation speed is representative of an operational status associated with the selected path.

13. The apparatus as recited in claim 11, wherein the animation speed is representative of an operational status associated with each of the communication paths in the selected path.

14. The apparatus as recited in claim 8, further comprising:
an input/output device in communication with the processor.

15. The apparatus as recited in claim 8, wherein the code is stored in the memory.

16. The apparatus as recited in claim 8, wherein the determined parameters are predetermined.

17. A computer-readable medium containing code thereon, the code operable for presenting operations associated with a network comprising a plurality of nodes and communications path between the nodes and for:
selecting a path that allows communications between two selected nodes, the path consisting of a plurality of communication paths providing communication between communicatively adjacent nodes;
determining parameters for animating the selected path; and
highlighting, alternately, selected portions of the display of the selected path based on the determined parameters, wherein the alternate highlighting provides a visual indication of a direction of data flow in the selected path.

18. The computer-readable medium as recited in claim 17 further containing code thereon for:
obtaining a status of the selected path; and
determining parameters for animating the selected path based on the status.

19. The computer-readable medium as recited in claim 17 further containing code thereon for:
obtaining a status of each of the communication paths between communicatively adjacent nodes; and
determining parameters for animating each of the communication paths between the communicatively adjacent nodes based on the associated status.

20. The computer-readable medium as recited in claim 17 further containing code thereon for selecting the animation parameters from the group consisting of: color, animation speed, animation direction.

21. The computer-readable medium as recited in claim 20, wherein the animation speed is representative of an operational status associated with the selected path.

22. The computer-readable medium as recited in claim 20, wherein the animation speed is representative of an operational status associated with each of the communication paths in the selected path.

23. The computer-readable medium as recited in claim 17, wherein the determined parameters are predetermined.
